(19) United States
(12) Patent Application Publication
(10) Pub. No.: US 2011/0177777 A1
(43) Pub. Date: Jul. 21, 2011

(54) BASE STATION, REPEATER, AND OPERATING METHOD THEREOF

(75) Inventor: Kanghee KIM, Daejeon (KR)

(73) Assignee: Electronics and Telecommunications Research Institute, Daejeon (KR)

(21) Appl. No.: 13/009,098

(22) Filed: Jan. 19, 2011

(30) Foreign Application Priority Data
Jan. 19, 2010 (KR) 10-2010-0004814
Jan. 12, 2011 (KR) 10-2011-0003138

(51) Int. Cl. H04B 17/02

(52) U.S. Cl. 455/9

(57) ABSTRACT

A base station provides information on a reference time to a repeater. The repeater determines a delay time based on a distance between the base station and the repeater, and determines an elapsed time of a delay time from the reference time as a transmission time. The base station transmits a positioning reference signal at the reference time. The repeater transmits a positioning reference signal at the transmission time.

### CROSS-REFERENCE TO RELATED APPLICATION

This application claims priority to and the benefit of Korean Patent Application No. 10-2010-0004814 filed in the Korean Intellectual Property Office on Jan. 19, 2010, and 10-2011-0003138 filed in the Korean Intellectual Property Office on Jan. 12, 2011, the entire contents of which are incorporated herein by reference.

### BACKGROUND OF THE INVENTION

(a) Field of the Invention

The present invention relates to a base station, a repeater and operating methods thereof. In particular, the present invention relates to operating methods of a base station and a repeater for wireless positioning.

(b) Description of the Related Art

For the wireless positioning method in wireless communication environment, there are many technologies such as time of arrival (TOA), time difference of arrival (TDOA), angle of arrival (ADA), delay spread of arrive (DSOA), and FingerPrint.

The TOA/TDOA method in which a distance between a transmitter and a receiver is measured based on an arrival time of a signal has been researched and used for a long time, but it does not provide accurate positioning in real environment due to a repeater, etc.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide apparatus and method for improving positioning accuracy by correcting a wireless positioning problem resulting from repeaters.

An exemplary embodiment of the present invention provides an operating method of a repeater comprising: determining a transmission time according to a distance between a base station and the repeater; and transmitting a positioning reference signal at the transmission time.

The operating method can further comprise: checking a reference time at which the base station transmits a positioning reference signal.

Determining the transmission time can comprise: determining a delay time based on the distance between the base station and the repeater; and determining, as the transmission time, an elapsed time of the delay time from the reference time.

The operating method can further comprise: receiving information on the reference time from the base station.

Transmitting the positioning reference signal can comprise: transmitting the positioning reference signal in the opposite direction of the base station's direction.

The operating method can further comprise: performing synchronization with the base station.

Determining the transmission time can comprise: receiving information on the transmission time from the base station to determine the transmission time.

Another embodiment of the present invention provides a repeater comprising: a transmission controller for determining a transmission time according to a distance between a base station and the repeater; and a transmitter for transmitting a positioning reference signal at the transmission time.

The transmission controller can check a reference time at which the base station transmits a positioning reference signal, determine a delay time based on the distance between the base station and the repeater, and determine an elapsed time of the delay time from the reference time as the transmission time.

The transmission controller can receive information on the reference time from the base station.

The transmitter can transmit the positioning reference signal in the opposite direction of the base station's direction.

Yet another embodiment of the present invention provides an operating method of a base station comprising: providing timing information to the repeater so that the repeater can transmits a positioning reference signal at a transmission time corresponding to the elapsed time of a delay time from a reference time, the delay time depending on a distance between the base station and the repeater; and transmitting a positioning reference signal at the reference time.

The timing information can include information on the reference time.

The timing information can include information on the transmission time.

Another embodiment of the present invention provides a base station comprising: a transmission controller for providing timing information to the repeater so that the repeater can transmits a positioning reference signal at a transmission time corresponding to the elapsed time of a delay time from a reference time, the delay time depending on a distance between the base station and the repeater; and a transmitter for transmitting a positioning reference signal at the reference time.

The timing information can include information on the reference time.

The timing information can include information on the transmission time.

### BRIEF DESCRIPTION OF THE DRAWINGS

FIG. 1 shows a wireless positioning system according to an exemplary embodiment of the present invention.

FIG. 2 shows a signal timing according to an exemplary embodiment of the present invention.

FIG. 3 shows a signal timing according to another exemplary embodiment of the present invention.

FIG. 4 is a block diagram representing a base station according to an exemplary embodiment of the present invention.

FIG. 5 a block diagram representing a repeater according to an exemplary embodiment of the present invention.

FIG. 6 is a flowchart representing a wireless positioning method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

In this specification, a mobile station (MS) may designate a terminal, a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In this specification, a base station (BS) may designate an access point (AP), a radio access station (RAS), a Node B, a base transceiver station (BTS), a mobile multihop relay (MMR)-BS, etc., and may include the entire or partial functions of the access point, the radio access station, the node B, the base transceiver station, the MMR-BS, etc.

Referring to drawings, a wireless positioning system according to an exemplary embodiment of the present invention will be described below.

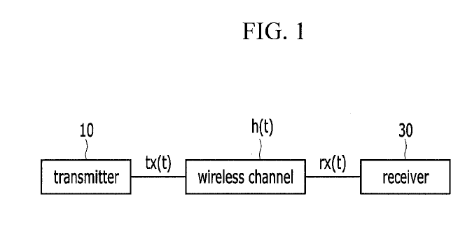

FIG. 1 shows a wireless positioning system according to an exemplary embodiment of the present invention.

As shown in FIG. 1, the wireless positioning system comprises a transmitter 10, a radio channel h(t), and a receiver 30.

The transmitter 10 transmits a specific signal. A transmitted signal is delayed via the radio channel h(t) and is transmitted to the receiver 30. The receiver 30 performs positioning by converting a delay time of the transmitted signal to a distance.

However, shadow areas can be formed by environmental influence in most of cellular systems. To solve this problem, various types of repeaters are used so that coverage can expand. Nevertheless, because the receiver can actually receive a signal that is generated by mixing a signal transmitted by an original transmitter with a signal transmitted by a secondary transmitter such as a repeater, a delay time of the signal received by the receiver may not be accurate unless the repeater compensates it.

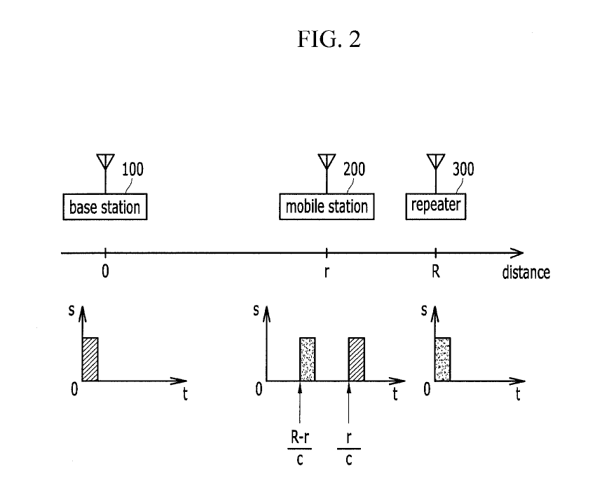

FIG. 2 shows a signal timing according to an exemplary embodiment of the present invention.

As shown in FIG. 2, a positioning system according to an exemplary embodiment of the present invention comprises a base station 100, a mobile station 200, and a repeater 300. Assume that a distance between the base station 100 and the repeater 300 is R, a distance between the mobile station 200 and the base station 100 is r, and the base station 100, the mobile station 200, and the repeater 300 are located in a single line.

As shown in FIG. 2, the base station 100 and the repeater 300 can simultaneously transmits a positioning reference signal at time 0. In case that the mobile station 200 can not distinguish a positioning reference signal of the repeater 300 from a positioning reference signal of the base station 100, the mobile station 200 can exactly measure a distance only if it receives a positioning reference signal with the delay time of r/C (C: speed of light).

However, if the mobile station 200 is closer to the repeater 300, mobile station 200 receives a positioning reference signal with the delay time of (R−r)/C first, so positioning accuracy can be damaged. In particular, in case that the mobile station 200 is very close to the repeater 300, positioning accuracy can be more greatly damaged.

This problem similarly occurs in a system which uses a plurality of antennas instead of a repeater. In this case, the damage of positioning accuracy results from locations of antennas and timing of a signal rather than from locations of repeaters or base stations.

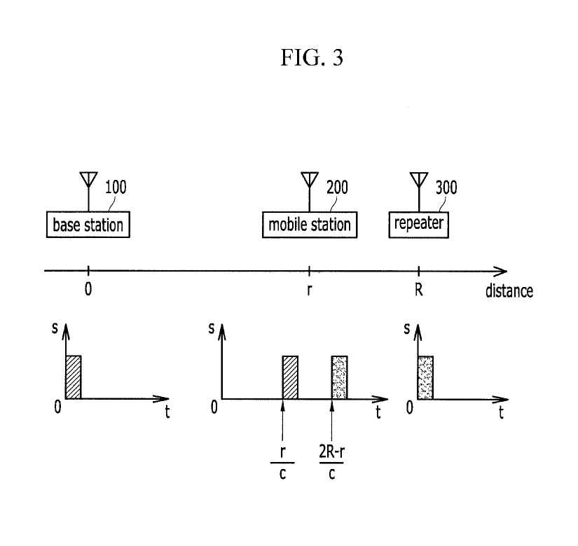

FIG. 3 shows a signal timing according to another exemplary embodiment of the present invention.

As shown in FIG. 3, a wireless positioning system according to another exemplary embodiment of the present invention comprises a base station 100, a mobile station 200, and a repeater 300. Assume that a distance between the base station 100 and the repeater 300 is R, a distance between the mobile station 200 and the base station 100 is r, and the base station 100, the mobile station 200, and the repeater 300 are located in a single line.

As shown in FIG. 3, the base station 100 transmits a positioning reference signal at time 0, and the repeater 300 transmits a positioning reference signal at time R/c. In this case, the mobile station 200 can receive at least one of a positioning reference signal with the delay time of r/c from the base station 100, and a positioning reference signal with the delay time of (2R−r)/c the repeater 300. In case that the mobile station 200 can receive both a positioning reference signal from the base station 100 and a positioning reference signal from the repeater 300, or in case that the mobile station 200 can receive only a positioning reference signal from the base station 100, the mobile station 200 can estimate a distance with the base station 100 by using a positioning reference signal with the delay time of r/c. In case that the mobile station 200 can receive only a positioning reference signal from the repeater 300, the mobile station 200 can estimate a distance with the base station 100 by using a positioning reference signal with the delay time of (2R−r)/c. Thus, even if the mobile station 200 is very close to the repeater 300, positioning accuracy cannot be greatly damaged.

In the other hand, in case that the mobile station 200 cannot receive a positioning reference signal from the base station 100, but can receive only a positioning reference signal from the repeater 300, if the mobile station 200 is located in the center of the base station 100 and the repeater 300, the mobile station 200 receives a positioning reference signal which undergoes greater delay than a delay in a real location, so positioning accuracy can be damaged. In this case, the repeater 300 can transmits a positioning reference signal so that the positioning reference signal can undergo a delay of r/C.

Also, as shadow areas are removed by using small repeaters, positioning shadow areas can be also removed. When a signal of the base station and a signal of the repeater are mixed, the SINR of a received signal can be strengthened and get greater. Also, it is possible to cancel a signal by using a directional antenna pattern and control the transmission power. For example, the repeater 300 cannot transmit a positioning reference signal by using the directional antenna pattern in direction of the base station 100 that the repeater 300 faces, but transmit a positioning reference signal in the opposite direction to the direction in which the repeater 300 looks at the base station 100 so that the positioning accuracy can be improved in case that the mobile station 200 can receive only a positioning reference signal from the repeater 300.

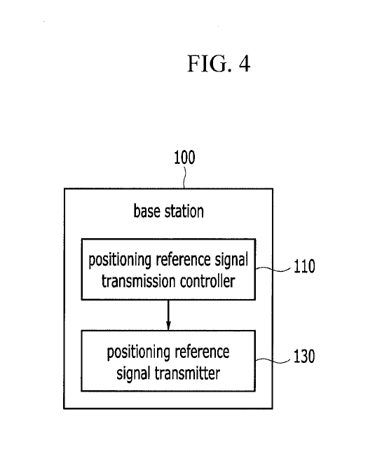

FIG. 4 is a block diagram representing a base station according to an exemplary embodiment of the present invention.

As shown in FIG. 4, the base station 100 comprises a positioning reference signal transmission controller 110 and a positioning reference signal transmitter 130.

The positioning reference signal transmission controller 110 controls a transmission timing of the positioning reference signal of the base station 100.

The positioning reference signal transmitter 130 transmits the positioning reference signal of the base station 100.

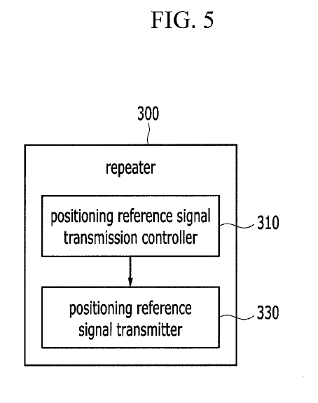

FIG. 5 a block diagram representing a repeater according to an exemplary embodiment of the present invention.

As shown in FIG. 5, the repeater 300 comprises a positioning reference signal transmission controller 310 and a positioning reference signal transmitter 330.

The positioning reference signal transmission controller 310 controls a transmission timing of the positioning reference signal of the repeater 300.

The positioning reference signal transmitter 330 transmits the positioning reference signal of the repeater 300.

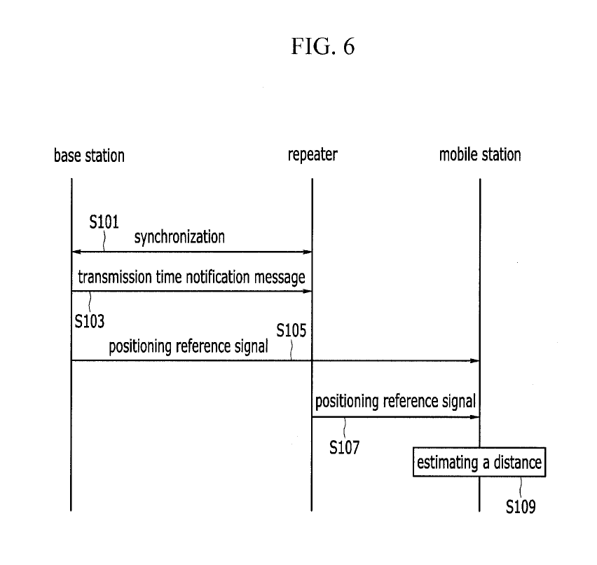

FIG. 6 is a flowchart representing a wireless positioning method according to an exemplary embodiment of the present invention.

First, the positioning reference signal transmission controller 110 of the base station 100 and the positioning reference signal transmission controller 310 of the repeater 300 performs synchronization for wireless positioning in step S101.

Next, the positioning reference signal transmission controller 110 of the base station 100 transmits a positioning reference signal transmission time notification message to the positioning reference signal transmission controller 310 of the repeater 300 in step S103. The base station 100 can notify a transmission time of the positioning reference signal of the base station 100 to the repeater 300

Also, the base station 100 can calculate a transmission time of a positioning reference signal of the repeater 300 based on a distance between the base station 100 and the repeater 300, and notify the transmission time of the positioning reference signal of the repeater 300 to repeater 300.

After this, the base station 100 transmits a positioning reference signal at a reference time in step S105.

The repeater 300 determines a time for transmitting a positioning reference signal from the positioning reference signal transmission time notification message, and transmits a positioning reference signal at a determined time in step S107. If the positioning reference signal transmission time notification message notifies a reference time for transmitting a positioning reference signal of the base station 100, after the repeater 300 delays a time R/c from the reference time, it can transmit the positioning reference signal. If the positioning reference signal transmission time notification message notifies a time for transmitting a positioning reference signal of the repeater 300, the repeater 300 can transmits a positioning reference signal at time directed by the positioning reference signal transmission time notification message.

The mobile station 200 receives at least one of a positioning reference signal from the base station 100 and a positioning reference signal from the repeater 300 to estimate a distance with the base station 100 in step S109. In case that the mobile station 200 can receive both a positioning reference signal from the base station 100 and a positioning reference signal from the repeater 300, or in case that the mobile station 200 can receive only a positioning reference signal from the base station 100, the mobile station 200 can estimates a distance with the base station 100 by using a positioning reference signal with the delay time of r/c. In case that the mobile station 200 can receive only a positioning reference signal from the repeater 300, the mobile station 200 can estimates a distance with the base station 100 by using a positioning reference signal of the repeater 300 with the delay time of (2R−r)/c.

According to aspects of the present invention, even if repeaters are used for eliminating positioning shadow areas, the positioning accuracy can be improved the wireless positioning system can be simplified. The wireless positioning system with the improved positioning accuracy can activate various location-based services.

The exemplary embodiments of the present invention are not implemented only by a device and/or method, but can be implemented through a program for realizing functions corresponding to the configuration of the exemplary embodiments of the present invention and a recording medium having the program recorded thereon. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An operating method of a repeater, comprising:
determining a transmission time according to a distance between a base station and the repeater; and
transmitting a positioning reference signal at the transmission time.

2. The operating method of claim 1, further comprising:
checking a reference time at which the base station transmits a positioning reference signal,
wherein determining the transmission time comprises:
determining a delay time based on the distance between the base station and the repeater; and
determining, as the transmission time, an elapsed time of the delay time from the reference time.

3. The operating method of claim 2, further comprising:
receiving information on the reference time from the base station.

4. The operating method of claim 3, wherein transmitting the positioning reference signal comprises:
transmitting the positioning reference signal in the opposite direction of the base station's direction.

5. The operating method of claim 4, further comprising:
performing synchronization with the base station.

6. The operating method of claim 1, wherein determining the transmission time comprises:
receiving information on the transmission time from the base station to determine the transmission time.

7. A repeater, comprising:
a transmission controller for determining a transmission time according to a distance between a base station and the repeater; and
a transmitter for transmitting a positioning reference signal at the transmission time.

8. The repeater of claim 7, wherein the transmission controller checks a reference time at which the base station transmits a positioning reference signal, determines a delay time based on the distance between the base station and the repeater, and determines an elapsed time of the delay time from the reference time as the transmission time.

9. The repeater of claim 8, wherein the transmission controller receives information on the reference time from the base station.

10. The repeater of claim 9, wherein the transmitter transmits the positioning reference signal in the opposite direction of the base station's direction.

11. An operating method of a base station, comprising:
providing timing information to the repeater so that the repeater can transmits a positioning reference signal at a transmission time corresponding to the elapsed time of a delay time from a reference time, the delay time depending on a distance between the base station and the repeater; and
transmitting a positioning reference signal at the reference time.

12. The operating method of claim 11, wherein the timing information includes information on the reference time.

13. The operating method of claim 11, wherein the timing information includes information on the transmission time.

14. A base station, comprising:
a transmission controller for providing timing information to the repeater so that the repeater can transmits a positioning reference signal at a transmission time corresponding to the elapsed time of a delay time from a reference time, the delay time depending on a distance between the base station and the repeater; and
a transmitter for transmitting a positioning reference signal at the reference time.

15. The base station of claim 14, wherein the timing information includes information on the reference time.

16. The base station of claim 15, wherein the timing information includes information on the transmission time.
